(19) United States
(12) Patent Application Publication
(10) Pub. No.: US 2001/0030589 A1
(43) Pub. Date: Oct. 18, 2001

(54) Three position solenoid

(76) Inventors: Derek A. Dahlgren, Wauwatosa, WI (US); Thomas J. Stobbs, Brookfield, WI (US); Diana Stobbs, Brookfield, WI (US)

Correspondence Address: REINHART BOERNER VAN DEUREN NORRIS & RIE, SELBACH, S.C., ATTN: LINDA GABRIEL, DOCKET COORDINATOR, 1000 NORTH WATER STREET SUITE 2100, MILWAUKEE, WI, 53202-3186, US

(21) Appl. No.: 09/796,245

(22) Filed: Feb. 28, 2001

Related U.S. Application Data
(60) Provisional application No. 60/185,898, filed on Feb. 29, 2000.

(51) Int. Cl. H01F 7/08

(52) U.S. Cl. 335/220

(57) ABSTRACT

A solenoid includes an armature movable relative to a pole member between a first position and second and third positions, a bias structure maintaining the armature at the first position, and a dual coil assembly driving the armature from the first position to the second and third positions The armature is maintained in the second or third position by permanent magnet latching, residual magnetism latching or a holding current. A magnetic structure for the armature comprises first and second magnet segments and a spacer member for directing magnetic flux produced near ends of the magnetic segments to the armature. A drive circuit for the solenoid includes a delatch circuit for allowing the armature to be returned to the first position by the bias structure in response to loss of power. The axial position of an armature can be determined using comparative inductance test procedure.

### BACKGROUND OF THE INVENTION

1. Field of the Invention

The present invention relates generally to solenoids, and more particularly, to a three position, solenoid used as a mechanical actuator.

The use of a motor or solenoid for actuating a functional device, such as moving a lock mechanism from a first, or locking position to a second or unlocking position, is known. Latching solenoids capable of maintaining a first and second position are commonly known.

Typically a motor is used for multiple positions which require control of linear position. In some cases, due to the mechanical design, it is required to have more than two discrete positions.

Electromagnetic actuators include a solenoid coil for moving an armature relative to a pole member or an end wall of a case of the actuator, for example, in carrying out a control function. When the armature is to be driven toward the pole member, initially, a large air gap will exist between opposing faces of the armature and the pole member. The air gap provides a high reluctance path for magnetic flux produced by the solenoid coil for driving the armature toward the pole member. The high reluctance results in a reduced magnetic force, particularly at the full stroke position for the armature. Consequently, a relatively large attractive force must be produced to move the armature toward the pole member. In known actuators, producing a greater force generally requires increasing the size of the solenoid coil, and resulting in a larger size for the solenoid package.

Both the response time of the actuator and the turn-on threshold are a function of the amount of attractive force produced by the device. The amount of force which can be generated by electromagnetic actuators is related to the relative sizes of the magnetic pole and the armature, the number of turns of solenoid coil and the current that is applied to the solenoid coil. The solenoid coil size generally determines the dimensions of the device because the solenoid coil is wound on the magnetic pole. Thus, methods of maximizing the attractive force generated by such devices are usually directed to optimizing the magnetic circuit of the device.

A further consideration is the need to distinguish discrete positions of a solenoid armature is known. Common techniques use external sensors or mechanical switches which can be expensive. Although inductance sensing can be used, tolerances in the solenoid allow the inductance of the solenoid to change. If this tolerance becomes too great, the windows could overlap and not allow this technique to be used. Also, short stroke solenoids will allow the inductance tolerances to overlap.

### SUMMARY OF THE INVENTION

The disadvantages and limitations of the background art discussed above are overcome by the present invention. With this invention, there is provided a solenoid which is capable of maintaining a third position in addition to first and second positions. In particular, the solenoid is ideally suited for use in mechanisms wherein the center position of the linear movement is a safe position. This safe position can be returned to with or without primary power available.

The solenoid comprises a magnetic pole member and an armature which is supported for movement relative to the magnetic pole member between a first position and at least second and third positions. The solenoid includes a bias structure which produces a bias force for maintaining the armature at the first position and a coil assembly which produces a first magnetic flux for driving the armature against the bias force from the first position to the second position and a second magnetic flux for driving the armature against the bias force from the first position to the third position. The armature is maintained by the effects of a magnetic force in the position to which the armature has been driven. The three position solenoid can use permanent magnet latching, residual magnetism latching or constant current for maintaining the armature in a position to which it has been driven.

In one embodiment, the coil assembly comprises first and second solenoid coils for driving the armature from the first position to the second position. The bias structure comprises a single spring element.

In one embodiment, the solenoid includes a magnetic structure for maintaining the armature at the second and third positions. The magnetic structure comprises a split permanent magnet assembly including first and second magnet segments and a spacer member interposed between the magnetic segments for directing magnetic flux produced near ends of the magnetic segments to the armature, thereby increasing the efficiency in the magnetic path by minimizing losses due to the configuration of the case or housing for the solenoid.

In accordance with a further aspect of the invention, a drive circuit for selectively applying drive signals to the first and second solenoid coils includes a delatch circuit for causing the armature to be returned to the first position in response to loss of power. The delatch circuit comprises first and second delatch pulse generators responsive to loss of power for applying a delatch pulses to both of the solenoid coils. Thus, if the armature is latched in either the second or third position, the magnetic latching force will be overcome, allowing the armature to be returned to the first, or center position upon loss of power, providing fail-safe operation of the latching solenoid, if necessary.

Further in accordance with the invention, there is provided a method for determining the axial position of an armature of a latching solenoid of the type that includes first and second solenoid coils for driving the armature from a first position to second and third positions. The axial position of the armature is determined using a comparative inductance test procedure in which test signals are applied to the first and second solenoid coils and the current flowing through the solenoid coils is measured at a predetermined time during the initial current rise and compared with current values stored in a look-up table. The relative magnitude of the currents sensed is indicative of the axial position of the armature. If the sensed currents are approximately equal, this indicates that the armature is at the centered position. If the current flowing through one of the solenoid coils is greater (or less) than the current flowing through the other solenoid, this indicates that the armature is at the second (or third) position. The multi-position sensing can be used to indicate the state of a multi-position solenoid, or the state of a lock in which the multi-position solenoid is incorporated.

### DESCRIPTION OF THE DRAWINGS

These and other advantages of the present invention are best understood with reference to the drawings, in which

FIG. 1 is an isometric view of the three position latching solenoid provided by the invention, a bias structure of the three position latching solenoid not being shown in FIG. 1;

FIG. 2 is an exploded view of the three position latching solenoid of FIG. 1;

FIG. 3 is a vertical section view of the three position latching solenoid taken along line 3-3 of FIG. 1 with the three position latching solenoid shown in the neutral position;

FIG. 4 is a view similar to that of FIG. 3 and showing the three position latching solenoid in an extended position;

FIG. 5 is a view similar to that of FIG. 3 and showing the three position latching solenoid in a retracted position;

FIG. 6 is a transverse section view of the three position latching solenoid of FIG. 1 illustrating magnet segments and a washer of the three position latching solenoid of FIG. 1;

FIG. 7 is a view similar to that of FIG. 6 and showing the magnetic fields produced by the magnet segments and the washer;

FIG. 8 is an elevation view of the armature of the three position latching solenoid of FIG. 1;

FIG. 9 is a vertical section view taken along the line 9-9 of FIG. 8;

FIG. 10 a top plan view of the washer of the three position latching solenoid of FIG. 1;

FIG. 11 is a side elevation view of the washer of FIG. 10;

FIG. 12 is an end elevation view of the washer of FIG. 10;

FIG. 13 is a top plan view of one of the permanent magnet segments of the three position latching solenoid of FIG. 1;

FIG. 14 is a front elevation view of the permanent magnet segment of FIG. 13;

FIG. 15 is a top plan view of a shunt ring of the three position latching solenoid of FIG. 1;

FIG. 16 is an elevation view of the shunt ring of FIG. 15;

FIG. 17 is a vertical section view taken along the line 17-17 of FIG. 16;

FIG. 18 is a vertical section view of a further embodiment of a position solenoid provided by the invention, which uses resilient magnetism for latching in the two positions away from a centered position;

FIG. 19 is a block diagram of a control circuit for the three position latching solenoid;

FIG. 20 is a vertical section view of the three position latching solenoid of FIG. 1 showing the main working air gap when the armature is at the centered position;

FIG. 21 is a view similar to that of FIG. 20 with the armature moved to a position intermediate the centered and retracted positions;

FIG. 22 is a view similar to that of FIG. 21 with the armature moved further toward the retracted position; and,

FIG. 23 is a graph showing attractive force as a function of displacement of the armature for the three position latching solenoid of FIGS. 1-9.

### DETAILED DESCRIPTION OF THE PREFERRED EMBODIMENTS

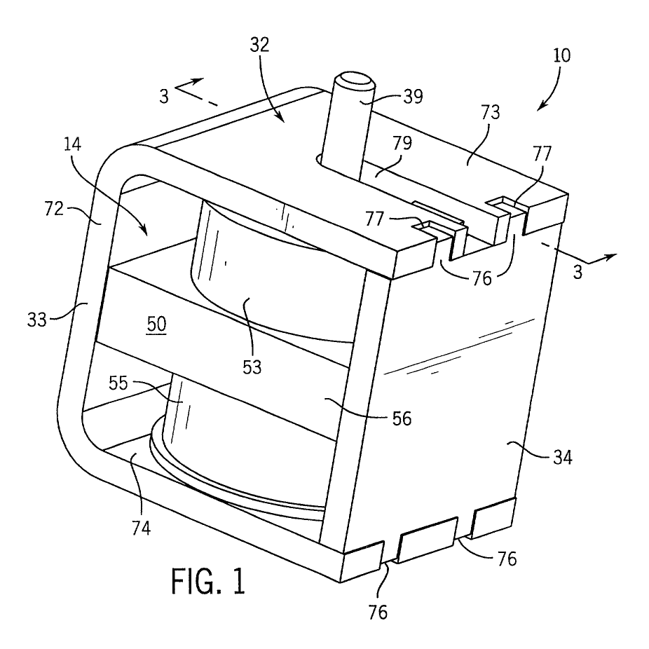

Referring to FIGS. 1-3 of the drawings, there is shown one embodiment of a three position latching solenoid 10 provided by the present invention. The three position latching solenoid 10 includes an armature 12, a dual coil assembly 14, an armature guide member 16, a bias structure 18, a pair of shunt rings 20 and 22 and a latching mechanism 24 including a pair of magnet segments 26 and 28 and a series washer 30. The latching solenoid 10 further includes an enclosure 32 including a frame 33 and a side plate 34 which partially enclose the components of the latching solenoid 10.

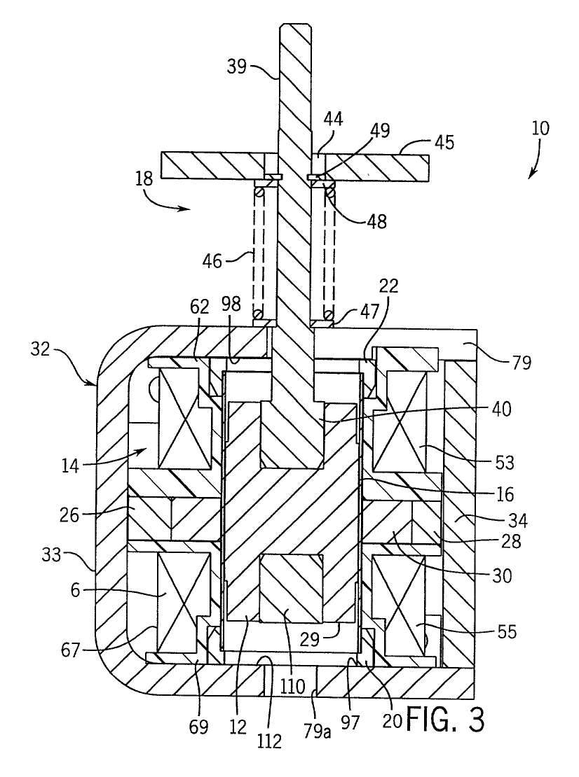

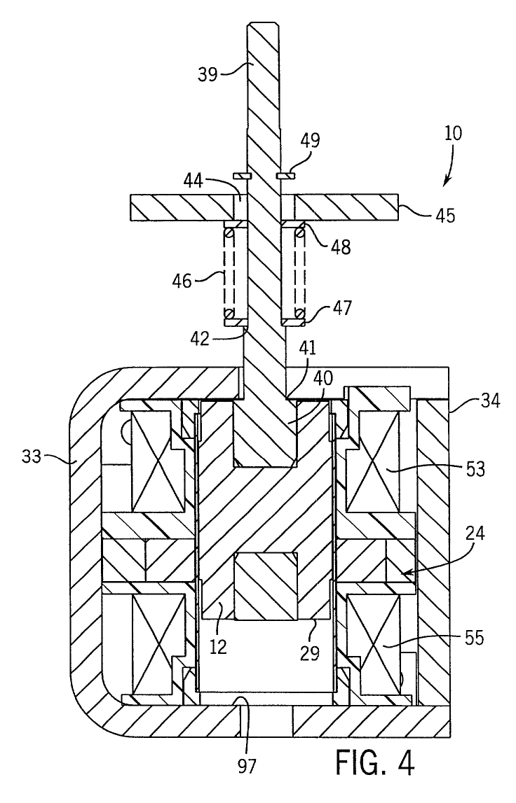

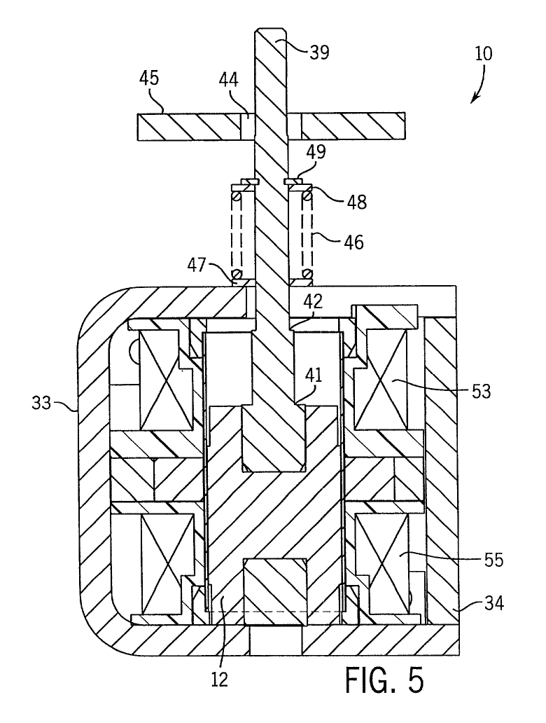

The armature 12 of the latching solenoid 10 is positionable at a centered or neutral position, shown in FIG. 3, at an extended position, shown in FIG. 4, and at a retracted position, shown in FIG. 5. The armature 12 is latched or maintained at the extended position and at the retracted position.

Armature

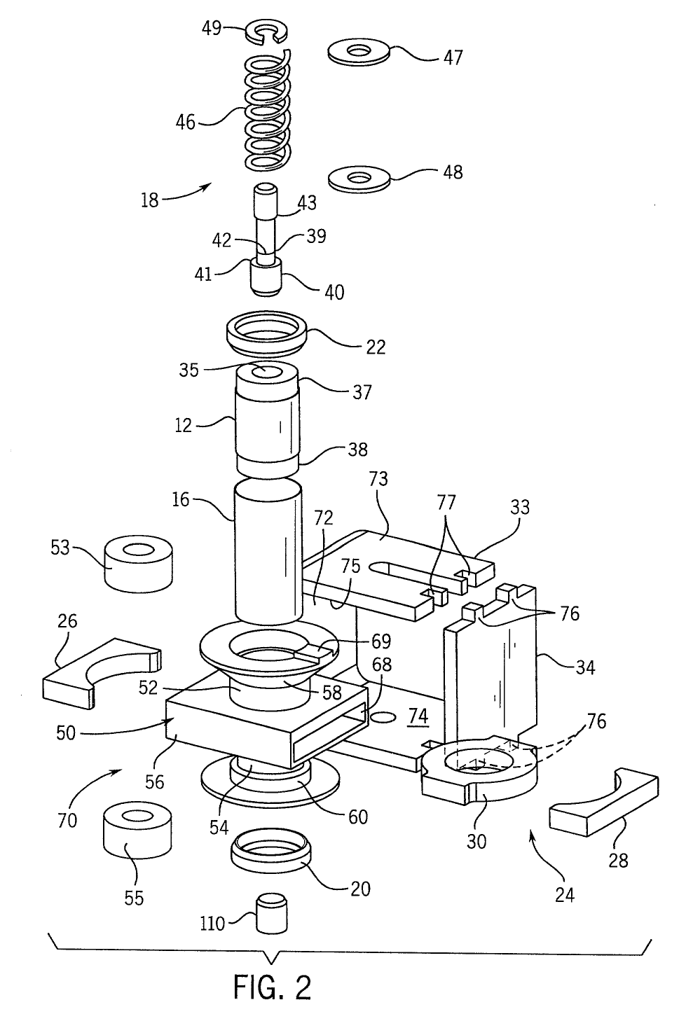

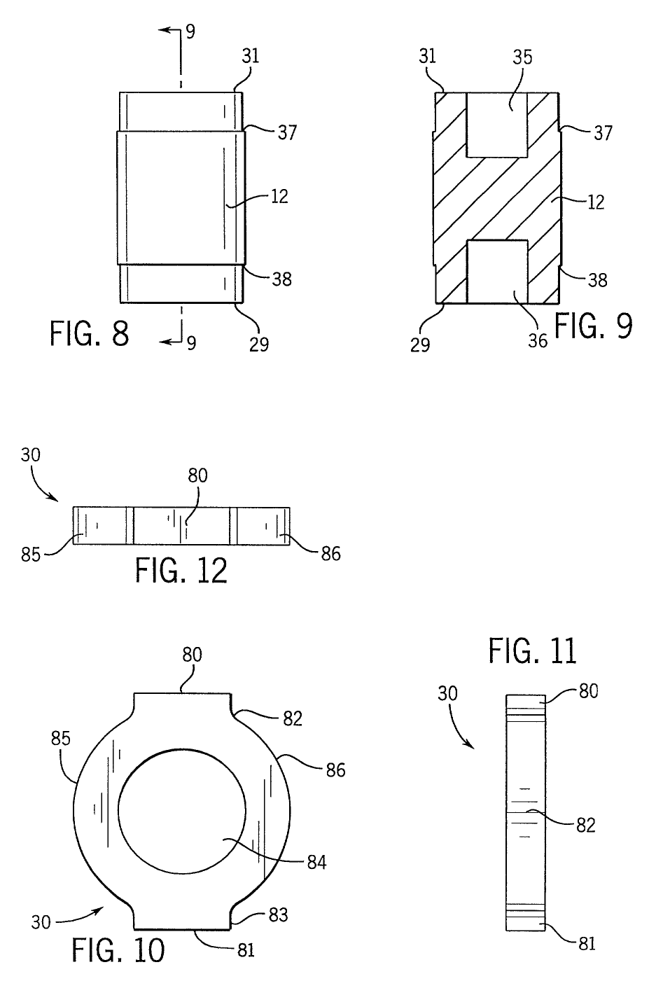

Referring to FIGS. 2, 3 and 8-9, the armature 12 is generally cylindrical in shape and includes axial recesses 35 and 36, which are generally circular in cross section, at opposite ends thereof. The armature 12 has reduced diameter portions which define shoulders 37 and 38 near the ends of the armature. The armature has a generally flat end surface 29 at one end and a generally flat end surface 31 at the opposite end.

The armature 12 is mounted within the solenoid coil sub-assembly 14 for reciprocating axial movement relative to the enclosure 32 from the centered position (FIG. 3) to the extended position (FIG. 4), and from the centered position to the retracted position (FIG. 5). The armature 12 is biased to the centered position by the bias structure 18. The armature 12 is driven by the a dual coil assembly 14 to the extended and retracted positions against the force of the bias structure 18.

In one embodiment, the armature 12 carries an attachment pin or shaft 39 which facilitates coupling the armature 12 to a functional device or mechanism that is controlled by the latching solenoid 10. The attachment pin 39 includes an enlarged proximal end portion 40 which is received in the recess 35 in one end of the armature 12. The end portion 40 can be retained in the recess 35 by an interference fit, or by any other suitable mechanical means. The end portion 40 defines a stop surface 41 for limiting axial movement of the armature 12. The attachment pin 39 includes a shoulder 42 near its proximal end portion 40 and a circumferential groove 43 near its distal end. The distal end of the attachment pin 39 extends through an aperture 44 through a mechanical stop 45.

Bias structure

Referring to FIGS. 2 and 3, the bias structure 18 includes a bias spring 46, a pair of stop washers 47 and 48 and a retaining ring 49. The stop washers 47 and 48 are mounted on the attachment pin 39. The bias spring 45 is also mounted on the attachment pin 39, trapped between the two washers 47 and 48. The retaining ring 49 is received in the groove 43 in the attachment pin 39 and keeps the components of the bias structure 18 together.

The washers 47 are 48 are interposed between the shoulder 42 and the retaining ring 49 and are free to slide along the portion of the attachment pin 39 that is located between the shoulder 42 and the retaining ring 49. The outer diameter of the washer 48 is greater than the inner diameter of the aperture 44, so that the washer 48 engages the surface of the mechanical stop 45 adjacent to the aperture 44 when the armature is in the centered or extended positions. The outer diameter of the retaining ring 49 is less than the inner diameter of the aperture 44 through the mechanical stop 45, allowing the retaining ring 49 to pass through the aperture 44 when the armature is moved to the extended position (FIG. 5).

In one embodiment, in which the bias structure 18 centers the armature 12 at the neutral position, the bias spring 46 is interposed between the frame 33 and the mechanical stop 45 as shown in FIG. 3. When the armature 12 is in the centered position as shown in FIG. 3, the washer 47 engages the surface of the frame 33 and the washer 48 engages the surface of the mechanical stop 45 and the spring 46 is non-compressed, or compressed only slightly.

When the armature 12 is in the extended position as shown in FIG. 4, the washer 47 is moved out of engagement with the frame 33 and the washer 48 remains in engagement with the surface of the mechanical stop 45 so that the retaining ring 49 has been moved through and past the mechanical stop 45, compressing the spring 46 between surface of the mechanical stop 45 and the washer 47 which bears against shoulder 42 on the attachment pin 39.

When the armature 12 is in the retracted position as shown in FIG. 5, the washer 48 has been pushed downwardly towards the frame 33 by the retaining ring 49 on the pin 39, while washer 47 is in engagement with the surface of the frame 33 so that the spring 46 is compressed between the washer 48 and the frame 33.

Other bias arrangements can be employed for centering the armature and allowing the armature to be driven to extended and retracted positions relative to the centered position. For example, two bias springs can be used, one located at each end of the armature. However, an advantage of the single spring bias structure 18 is that this bias structure does not require two matched bias springs.

Dual Coil assembly

Referring to FIGS. 1-3, the dual coil assembly 14 includes a bobbin 50 having a coil receiving portion 52 on which is wound a solenoid coil 53 and a coil receiving portion 54 on which is wound a solenoid coil 55. The bobbin 50 further includes a generally rectangular body portion 56 which is located between the coil receiving portions 52 and 54. In one embodiment, the bobbin is made of plastic and preferably, the bobbin 50 is molded as a one-piece element.

In one embodiment, the solenoid coils 53 and 55 of the dual coil assembly 14 are step-wound to accommodate the shunt rings 20 and 22. The coil receiving portions 52 and 54 for respective solenoid coils 53 and 55 are formed to have a step or shoulder near one end, as indicated by the reference numerals 58 and 60 in FIG. 2. The steps 58 and 60 define annular channels 62 and 64 at the outer ends of the bobbin 50 in which are located the shunt rings 20 and 22, respectively. Because of the stepped configuration, each solenoid coil, such as solenoid coil 55, includes a winding portion 66 and winding portion 67 which has an inner diameter that is larger than the inner diameter of the winding portion 66. Preferably, the two solenoid coils 53 and 55 are alike and have the same number of turns, are wound of the same size wire, etc.

The center portion 56 of the bobbin 50 includes a slot 68 for receiving the magnet segments 26 and 28 and the washer 30 of the armature latching structure 24. This mounting arrangement makes it easier to assemble the magnet segments 26 and 28 and the washer with 30 the solenoid coils 53 and 55 forming a solenoid coil sub-assembly 70 which is then assembled with the armature 12, the shunt rings 20 and 22, the guide sleeve 16, etc., prior to sliding the assembled components, including the solenoid coil sub-assembly 70, into the frame 33. Although in one preferred embodiment the permanent magnet segments are located at or near the center of the solenoid coil assembly, a single permanent magnet, or a plurality of permanent magnets or permanent magnet segments, can be located at other positions within the magnetic circuit as commonly known in the art. Moreover although the enclosure 32 has an open frame construction and the armature latching structure 24 includes a pair of permanent magnet segments arranged to form a generally annular magnet structure, the enclosure can be tubular in shape and the magnetic structure can be formed by a ring shaped permanent magnet or by a pair of magnets which are located at opposite ends of the armature or mounted on the pole faces. The configuration of the center portion 56 of the bobbin 50 provides a square interface between the two coil receiving portions 52 and 54 of the bobbin 50 for indexing to the frame 33 of enclosure 32. One of the bobbin portions 52 includes a notch or projection 69 for aligning the solenoid coil sub-assembly 70 to the frame 33 of the enclosure 32.

One of the solenoid coils 53 is used to drive the armature 12 from the centered position to the extended position. The other solenoid coil 55 is used to drive the armature 12 from the centered position to the retracted position.

Enclosure

The enclosure is a two-part assembly including frame 33 and side plate 34 providing an open frame configuration for the enclosure 32. The frame 33 is a generally C-shaped member having a base 72 (FIG. 1), parallel arms 73 and 74 which project outwardly from the base 72, and an open end 75 which is adapted to receive the solenoid coil sub-assembly 70. The arm 73 includes a slot 79 for receiving the pin 39 when the solenoid coil sub-assembly 70 is inserted into the frame. The arm 74 includes an aperture 79a therethrough for venting the interior of the guide sleeve 16 during movement of the armature 12 to prevent a vacuum from being formed.

The side plate 34 is a generally flat member which is adapted to be mounted on the frame 33 closing the open end 75 of the frame 33. The side plate 34 can be secured to the frame 33 by folding over tabs 76 which are received in mating slots 77 on the frame 33.

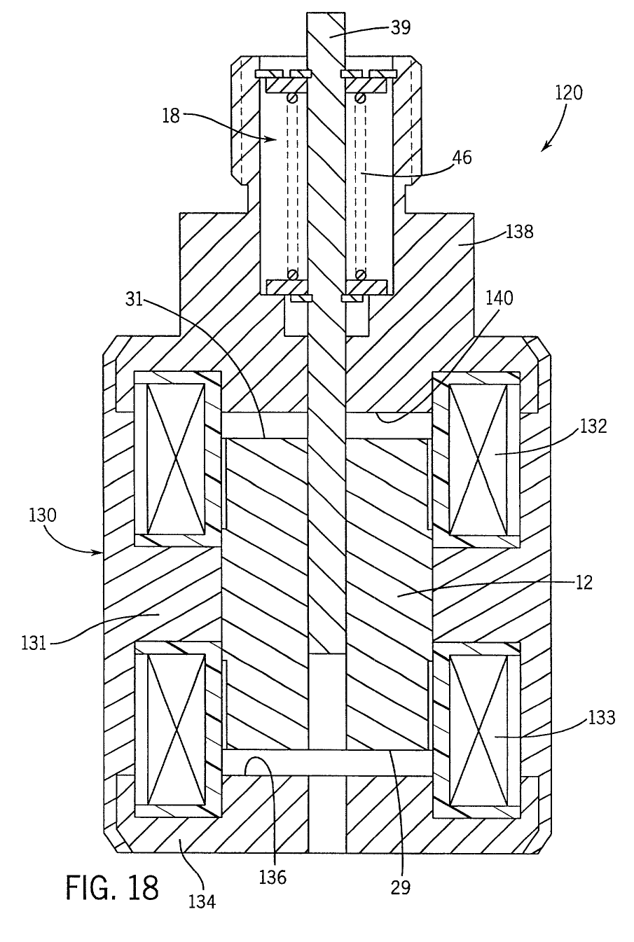

The solenoid coil sub-assembly slides into the opening 75 defined by the parallel arms 73 and 74 of the frame 33. The frame 33 can include one or more mounting holes 78(FIG. 18) to facilitate mounting the latching solenoid 10 on apparatus with which the latching solenoid is used. The arm 74 has a flat surface 97 opposing the end surface 29 of the armature. Similarly, the arm 73 has a flat surface 98 opposing the end surface 29 of the armature. Surfaces 97 and 98 function as pole faces for the latching solenoid 10.

Armature Latching Structure

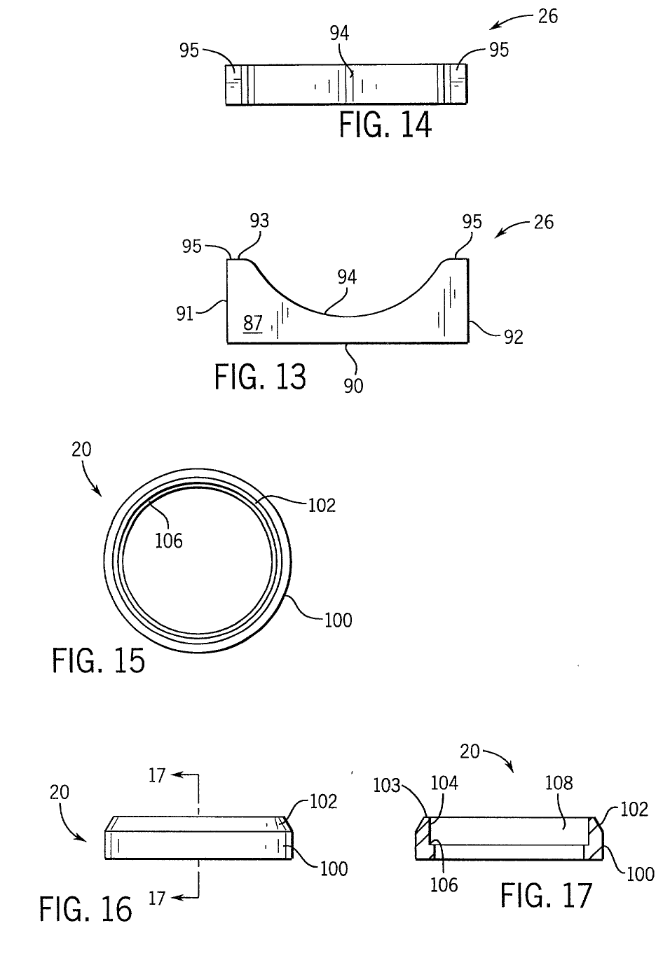

Referring to FIGS. 2, 3, 6 and 10-14, the latching solenoid 10 uses a split permanent magnet arrangement for latching or maintaining the armature in a position to which it has been driven. In one embodiment, the split permanent magnet arrangement includes two magnet segments 26 and 28, and a spacer member or washer 30.

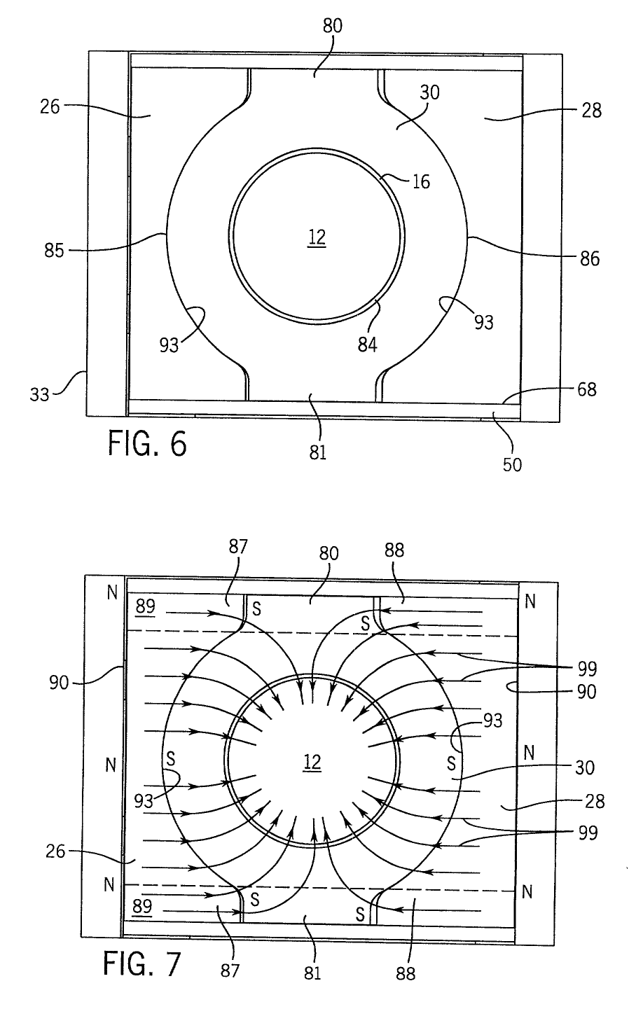

The washer 30 is flared out defining ears 80 and 81 at one pair of opposite ends 82 and 83. The ears 80 and 81 increase the efficiency in the magnetic path, by minimizing losses due to the open frame configuration for the enclosure 32. The washer 30 has a central aperture 84 therethough, for allowing the armature 12 to pass through the washer 30 as shown in FIGS. 3 and 6, for example. The washer 30 is made of a magnetically permeable material such as steel and is positioned to be in “series with the magnet segments 25 and 28.

The magnet segments 26 and 28 are alike and accordingly only one magnet segment 26 will be described. Magnet segment 26 has a straight side 90, straight ends 91 and 92 and a side 93 including an arcuate side portion 94 and straight portions 95 on opposite sides of the arcuate portion 94. The radius of curvature of the arcuate side portion 94 is the same as that for the side 85 of the washer 30. The length of the side 90 is the same as the length of the washer between the ears 80 and 81.

The generally arcuate sides 93 of the magnet segments 26 and 28, allow the magnet segments to be positioned at or around the outside edge of the washer 30 at opposite sides 85 and 86 of the washer 30. The length of the straight portions 95 of side 93 is approximately the same as the length of the ears 80 and 81. The thickness of the magnet segments 26 and 28 is the same as the thickness of the washer 30 as shown in FIG. 3, for example.

Referring also to FIG. 7, the magnet segments 26 and 28 are polarized axially and are polarized to have opposite polarities. In one embodiment, the magnet segments are polarized to have a positive polarity “N” along the straight edge 90 and a negative polarity “S” along the curved side 93. The flared portions 80 and 81 channel or direct the portion of the magnetic flux which is produced near the outer ends 87 and 88 of the magnet segments 26 and 28, respectively, to the “center” of the armature 12.

FIG. 7 is a simplified representation or approximation of the magnetic field lines or paths 99 for magnetic flux produced by the magnet segments 26 and 28. The magnetic field lines through the permanent magnets 26 and 28 are basically straight along polar alignment. The presence of the ears 80 and 81 produces nearly a 360° field being applied to and around the armature 12 and the working gap. Thus, the magnetic flux that is produced near the ends 87 and 88 of the magnet segments 26 and 28 also is directed to the armature 12.

In known arrangements which use a linearly magnetized magnet segments and no metal washer, or magnet segments and a circular washer, magnetic flux that is produced in the regions 89 enclosed within the dashed lines, near the ends of the magnet segments 26 and 28 is lost. The shape of the washer 30 in accordance with the invention results in a more efficient magnetic path because the magnetic flux produced near the outer ends 87 and 88 of the magnet segments 26 and 28 is directed to the armature 12.

Shunt Ring

Referring to FIGS. 2, 3 and 15-17, the latching solenoid 10 includes a magnetic flux shunt structure for providing a low reluctance magnetic flux path between the armature 12 and the enclosure 33 as the armature 12 is driven toward and away from one of the latched positions.

In one embodiment, the shunt structure includes a pair of ring shaped members 20 and 22 which preferably are separate elements from the armature 12 and the pole face defining portion of the enclosure 32. Thus, in preferred embodiments, the shunt members, or shunt rings 20 and 22 are a free floating with respect to the enclosure 32 and the armature 12. That is, the shunt rings 20 and 22 are not fixed or attached to the enclosure 32 or to the armature 12. Rather, the shunt rings 20 and 22 are positioned in relationship with the armature 12 by an element of a non-magnetic material which can be a portion of the bobbin 50 of the solenoid winding or a separate element or guide sleeve 16, for example.

With reference to FIGS. 15-17, the shunt rings 20 and 22 are alike and accordingly, only one of the shunt rings 20 is described. Shunt ring 20 has a side wall 100 with a beveled edge 102 with a flat upper surface 103. Alternatively, the shunt ring 20 can have parallel side surfaces. The inner surface 104 of the shunt ring is stepped, defining an annular shoulder 106. The shunt ring 20 includes an opening 108 therethrough.

The shunt ring 20 is mounted in the channel 64 defined by the stepped portion 60 of the bobbin 50. Similarly, the shunt ring 22 is mounted in the channel 62 defined by stepped portion 58 of the bobbin 50, oriented upside down with respect to the shunt ring 20. The side wall portion 100 of the shunt ring 20 extends above the pole face 97, bridging a portion of the axial air gap 112 between the pole face 97 and the opposing surface 29 of the armature 12.

The inner diameter of the two shunt rings 20 and 22 is greater than the outer diameter of the armature 12, allowing the armature 12 to be moved substantially axially relative to the pole faces, through the shunt rings into engagement with one of the pole faces, depending upon the direction in which the armature 12 has been moved. Generally, the length of the stroke dictates the width of the shunt rings, i.e., the vertical height of the shunt rings as viewed in FIG. 3, for example. That is, the width or height of the shunt rings 20 and 22 above the associated pole surface is approximately equal to the width of the working air gap.

The separate shunt rings 20 and 22 allow the enclosure 32 and/or the armature 12 to be made of a material that is different from the material of the shunt members 20 and 22. For example, in one preferred embodiment, the shunt rings 20 and 22 are of a soft material which provides for improved pull-in force from the unlatched to the latched position. The armature 12 and at least the portions of the frame 33 of the enclosure 32 which define the pole faces 97 and 98, can be of hardened material which provides for improved residual latching forces in the latched position.

The armature guide member or sleeve 16 maintains the shunt rings 20 and 22 concentric with the armature 12 which is guided by the guide sleeve 16. In one embodiment, the guide sleeve 16 rests on the shoulders 106 of the shunt rings 20 and 22.

Latch Force Setting

In accordance with a further aspect of the invention, the latch force that is needed to latch or maintain the armature 12 in the extended and retracted positions is adjusted by setting the gap 112 between inner surface 29 of the armature 12 and the pole face 87, which is defined by the inner surface of arm 73 of the frame 33. In one embodiment, this is accomplished by mounting an insert or plug 110 of a non-magnetic material in the recess 36 in the end of the armature 12 that is located adjacent to the pole face. The non-magnetic insert 110 extends beyond the armature surface 29 to set the latch force. The provision of the insert 110 allows a common armature 12 to be used for a plurality of latching solenoids, which have different magnetic forces. A portion of the insert 110 projects axially from the end of the armature. The position of the insert 110, and thus the length of the portion of the insert 110 projecting from the armature end, can be fixed or can be adjustable. The axial position of the end portion 40 of the pin 39 also can be adjusted to set the gap between the shoulder 41 of pin 39 and the pole face 98 on the inner surface of arm 73.

Because the latch force is adjusted by setting the gap rather than by controlling the surface areas which define the pole face and the armature face, the mechanical adjustment using the insert will generally result in lower field strengths.

Residual latching

Although in one embodiment, the latching solenoid 10 includes a permanent magnet segments 26 and 28 for providing the latching function, residual magnetism can be used to maintain the armature 12 in a position to which it has been driven. FIG. 18 is a simplified representation of a three position latching solenoid 120 which employs the effects of residual magnetism for maintaining the armature 12 in the extended and retracted position. The latching solenoid 120 is similar to latching solenoid 10 and accordingly, elements of latching solenoid 120 have been given the same reference numerals as corresponding elements of latching solenoid 10. However, latching solenoid does not include the armature latching mechanism 24 of latching solenoid 10. A generally tubular body 130 of steel or other magnetic material surrounds dual solenoid coils 132 and 133, and includes an annular portion 131 extending between the solenoid coils 132 and 133. Also, the latching solenoid 120 includes a magnetic pole member 134 defining pole face 136 disposed adjacent to face 29 of the armature and a magnetic pole member 138 defining pole face 140 disposed adjacent to the other face 31 of the armature. The pole faces 136 and 140 are flat surfaces which are adapted to be engaged by flat armature surfaces 29 and 31, respectively, providing substantially no air gap between the mating surfaces In addition, the components of the bias structure 18 are reversed, top to top, from those of latching solenoid 10.

The latching solenoid 120 is shown in FIG. 18 with the armature 12 centered. The armature 12 is driven to the extended position by applying a pulse to solenoid coil 132. The armature 12 is driven to the retracted position by applying a pulse to solenoid coil 133. The armature is maintained in the extended and retracted positions by the effects of residual magnetism. The armature is returned to the centered position from the extended position by applying a release pulse to the solenoid coil, which is of opposite polarity and significantly reduced amplitude relative to the drive pulse, for canceling the effects of residual magnetism between the armature 12 and the pole member 136. Consequently, the net magnetic attractive force is less than the force produced by the bias structure 18, allowing the armature 12 to be returned to the centered or neutral position by the bias spring 46. Similarly, the armature is returned to the centered position from the retracted position by applying a pulse to the solenoid coil 133 for producing a magnetic field in the direction opposite to that produced by, and equal to or similar to the magnetic field produced by the effects of residual magnetism between the armature 12 and the pole member 134.

For applications in which residual magnetism is used to maintain the armature 12 in a position to which it is driven, the structure forming the magnetic circuit preferably is of a soft magnetic material, such as a soft steel, and the armature 12, at least the pole face defining member, such as arm 73 (and arm 74)of the frame 33, are of a hard magnetic material, such as a high carbon hardened steel or other magnetic materials which exhibit optimal residual properties.

In latching solenoid 120 in which the effects of residual magnetism are used to latch the armature 12 in the extended and retracted position, the armature 12 and enclosure 32 preferably are constructed from a material which has hysterisis that maintains the position of the armature 12 against the spring load that is produced by the bias structure 18 even when power to the solenoid coils is terminated. For example, the material can be a 52100 or 440C steel. The magnetic steel material allows the armature 12 to be latched into the first or second position by providing a digital pulse to the solenoids. The armature 12 can be returned to the neutral position preferably by providing a voltage of opposite polarity to the solenoid adjacent to the armature to free the armature 12 from the pole face of the frame 33, or by providing a short pulse on the opposite solenoid. The thus freed armature 12 is biased into the neutral position by the bias structure 18.

A further embodiment for a three position solenoid employs constant current for maintaining the armature 12 in the extended and retracted positions. The solenoid coil 53, or 55, that drives the armature 12 to the extended, or retracted, position is maintained energized by a holding current at a lower level than that which is used to drive the armature 12 to the extended or retracted position.

Thus, the three position solenoid 10 can use permanent magnet latching, residual magnetism latching or constant current for maintaining the armature 12 in the extended and retracted positions.

Position Sensing

In many applications, it is desirable to provide an indication of the state of a multi-position solenoid, as indicated, for example, by the position of the armature. In one embodiment, a comparison technique is used for determining three positions of the armature 12 of latching solenoid 10, namely the centered position, the extended position, and the retracted position. This can be done in any known way. One way is to apply to each of the solenoid coils 53 and 55 a low voltage of an amplitude which does not affect the solenoid state, and monitor the current rise.

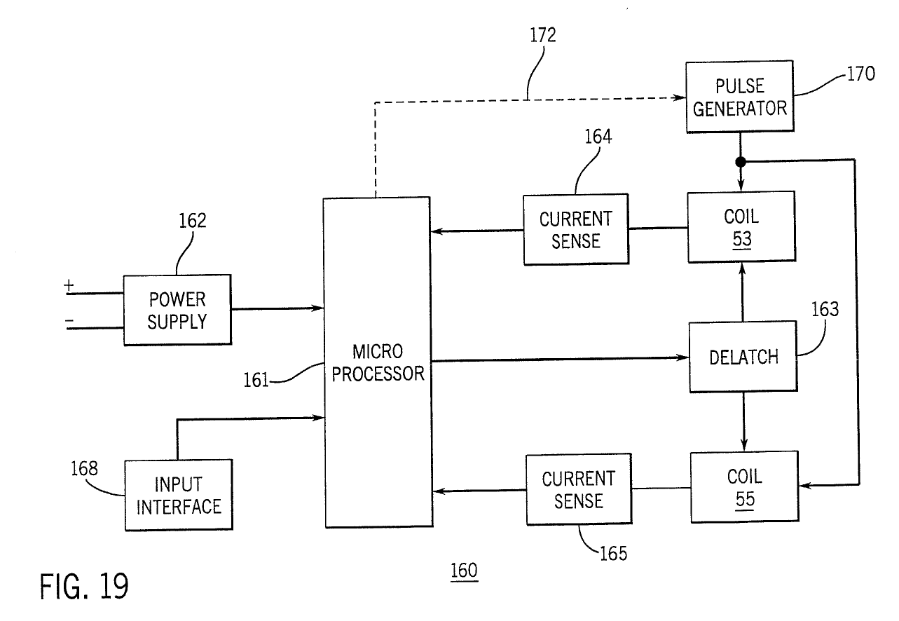

In one embodiment, to conduct a comparative position inductance check for the three-position latching solenoid 10, a small test voltage is applied in sequence to the solenoid coils 53 and 55 for a short period of time, for example, about 150 microseconds. The amplitude of the test voltage applied to the solenoid coils is significantly smaller than the voltage used to energize the solenoid coils to drive the armature to its extended or retracted position and with the normal drive polarity so that the solenoid is not actuated during the position check. Preferably, the test voltage applied for position sensing can be one-third, and preferably much less than one-third the amplitude of the minimum drive voltage for the solenoid coils 53 and 55. The current is sensed and recorded at a known period of time, such as at about 150 microseconds or at a time previously determined at which current has not exceeded peak amplitude. This current value is compared to values stored in a lookup table in the program of a microprocessor, such as microprocessor 161 shown in FIG. 19, and the position of the armature, and thus the state of the latching solenoid 10 is determined based upon the relative magnitudes of the current sensed for the two solenoid coils. The look-up table is constructed by calculating inductance values for the coils at the three positions and for preselected parameters, including coil resistance, the test voltage level, and current sampling time with relative to time a drive signal is applied to the coil.

The inductances can be calculated from the derivative of current with respect to time as is known. By way of example, for a two coil solenoid having coil resistances of 4.65 ohms, with a voltage pulse having an amplitude of about 2 volts applied to the each coil, and the current flowing through the coils being measured at 150 microseconds, the calculated inductances when the armature is at the extended position are:

L(coil 53) is approximately 0.0055 Henries

L(coil 55) is approximately 0.0009 Henries

For the same conditions, the calculated inductances when the armature is at the centered position are:

L(coil 53) is approximately 0.0021 Henries

L(coil 55) is approximately 0.0021 Henries

For the same conditions, the calculated inductances when the armature is at the retracted position are:

L(coil 53) is approximately 0.0009 Henries

L(coil 55) is approximately 0.0055 Henries

For the armature in the extended position, the current flowing through solenoid coil 53 is approximately 0.0545 amps and the current flowing through solenoid coil 55 is approximately 0.333 amps.

For the armature in the centered position, the current flowing through solenoid coils 53 and 55 is approximately 0.143 amps.

For the armature in the retracted position, the current flowing through solenoid coil 53 is approximately 0.333 amps and the current flowing through solenoid coil 55 is approximately 0.0545 amps.

To determine the position of the armature, the test voltage is applied to the solenoid coils 53 and 55 in sequence and the current flowing through the coils 53 and 55 is sensed during the initial current rise at a time 150 microseconds after the test pulse is applied and the current values sensed are recorded. The current values obtained are compared with current values stored in the look up table. Alternatively, position sensing can be done by determining a relative relationship between the currents flowing through the solenoid coils 53 and 55 rather than obtaining a current magnitude value. For example, if the current values sensed are within a range of current values or by determining a percent difference between the two current values sensed.

Thus, if the current flowing through solenoid coil 55 is less than the current flowing through solenoid coil 53, this indicates that the armature 12 is at the extended position.

If the current flowing through solenoid coil 55 is substantially equal to the current flowing through solenoid coil 53, this indicates that the armature 12 is in the centered position.

If the current flowing through solenoid coil 53 is greater than the current flowing through solenoid coil 53, this indicates that the armature 12 is at the retracted position.

The results of these comparisons are approximate and do not necessarily represent the actual end positions. However, because of the separation between the extended and retracted positions, the inductance value, and thus, the indicated difference at the two end positions is greater than that obtained for a two position solenoid. Thus, the two end positions can be more readily differentiated.

Delatch Circuit

The latching solenoid 10 can include a delatch function by which the armature 12 is delatched in response to an interruption of power, providing fail safe operation of the latching solenoid 10, if necessary. Delatch circuits are known in the art and one delatch circuit is disclosed in U.S. Pat. No. 4,409,638 of Oded E. Sturman et al., which is entitled Integrated Latching Actuators. The '638 Patent to Sturman et al., is incorporated herein by reference.

The delatch circuit disclosed in the '638 Patent controls a single coil. The '638 Patent discloses a logic circuit which causes a single actuator to latch when power is applied to the circuit and which causes a pulse to be applied to the coil to delatch the actuator when the supply of power to the circuit is interrupted. The delatch pulse is produced by storage capacitors which are charged by the supply voltage and are caused to discharge into the coils upon loss of power, causing the actuator to return to a fail-safe position.

Referring to FIG. 19, there is illustrated a block diagram of a control circuit 160 for the latching solenoid 10. In accordance with a further embodiment of the invention, the latching solenoid 10 can be operated under microprocessor control in providing a delatch function. Power is supplied to the microprocessor 161 by a power supply circuit 162 which produces suitable dc voltages from a power input signal. The microprocessor 161 can monitor the power being supplied and respond to an interruption of power to provide fail safe delatching of the latching solenoid 10. The control circuit 160 can include a delatch pulse generator 163, preferably comprising storage capacitors (not shown), one associated with each solenoid coil 53 and 55. The capacitors are maintained charged and are caused to discharge into the solenoid coils, in response to loss of power.

For example, the microprocessor 161 can be programmed to cause the armature 12 to be delatched from either the extended position or the retracted position. Moreover, the microprocessor 161 can be programmed to operate in a redundant mode and cause delatching pulse to be applied to both solenoid coils 53 and 55 regardless of current position. Moreover, the microprocessor 161 can be programmed to cause the armature 12 to be delatched on the basis of results of the comparative position sensing in which case, a delatch pulse is applied only to the solenoid coil associated with the position in which the armature currently is latched. This function can be provided using a single delatch pulse generator.

The microprocessor 161 also can be used in comparative position inductance for indicating the state of the solenoid. The indication of the state of the solenoid can be used to determine current safe failure modes for the latching solenoid. The microprocessor can monitor current sensing devices 164 and 165 which are coupled to the solenoid coils 53 and 55. The program for the microprocessor can include a look-up table for use in comparative position inductance check for the latching solenoid 10. The control circuit 160 can include an input interface 168 to permit parameters and other data to be supplied to the microprocessor 161 and to allow information to be outputted from the microprocessor 161. The microprocessor 161 can also control, through a suitable interface 172, one or more pulse generators 170 which produce the drive and test pulses for the solenoids 53 and 55. However, the pulse generator or generators for actuating the latching solenoid 10 can be separate circuits and/or the drive and test pulses can be produced by control equipment associated with the apparatus with which the latching solenoid 10 is used.

Operation

To drive the armature 12 from the centered position to the extended position, a drive pulse of a first polarity is applied to solenoid coil 53. The drive pulse has the same polarity as the field produced by the permanent magnet segments 26 and 28. The application of a drive pulse to the solenoid coil 53 causes a magnetic field to be produced which adds to the magnetic field produced by the permanent magnet segments. The resultant magnetic field causes the armature 12 to be moved toward the extended position. The bias spring 46 is compressed as the armature 12 is moved away from the centered position.

The armature 12 is maintained in the extended position by the magnetic field produced by the permanent magnet segments 26 and 28. (or by the effects of residual magnetism, or by a magnetic field produced by a holding current applied to the solenoid coil).

To release the armature 12 from a latched position, a release pulse is applied to the solenoid coil 53 for producing a magnetic field in the direction opposite to that produced by the permanent magnet segments 26 and 28, and equal to or similar to the permanent magnet field. Consequently, the net magnetic attractive force is less than the force produced by the bias structure 18, allowing the armature to be returned to the centered or neutral position by the bias spring 46.

Similarly, solenoid coil 55 drives the armature 12 from the centered position to the retracted position in the same manner and the armature 12 is returned to the centered position in the same manner.

When the armature is to be moved from the extended or retracted position to the retracted or extended position, the drive pulses are applied to the solenoid coils 53 and 55 in sequence. Assuming that the armature 12 is latched in the extended position, first a release pulse is applied to the solenoid coil 53 to reduce the magnetic force below the force being produced by the bias structure 18, allowing armature to return to centered position. When the armature has been returned to the centered position, a drive pulse is applied to the solenoid coil 55 to move the armature 12 to the retracted position where the armature is latched by the permanent magnet field.

Graphs

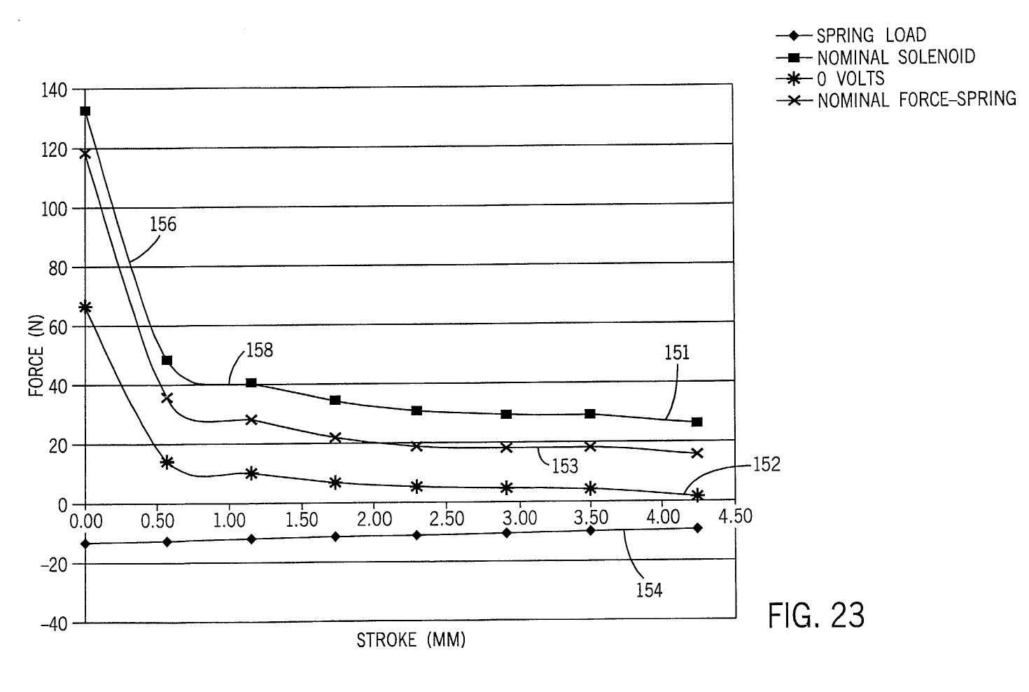

Referring to FIG. 23, there is shown curves 151-154 representing magnetic attraction force as a function of displacement of the armature 12 for the three position latching solenoid 10, when the armature is moved between the centered and extended positions. The right side of the curves 151-154 represents the magnetic force when the armature is at the centered position. The left side of the curves 151-154 represents the magnetic force for the condition where the armature is in the extended position. The force versus position curves for the condition where the armature is moved from the centered position to the retracted position are symmetrical to curves 151-154, but in opposite force direction.

The curves 151-154 illustrate the generally linear magnetic force characteristic provided by the latching solenoid 10 over most of the stroke. The curve 151 is for the condition when the solenoid coil 53 is energized, and the effects of the bias force produced by bias spring 46 are ignored. Curve 154 represents the effect of the bias force on the armature. The three-position latching solenoid 10 uses a linear spring. However, the latching solenoid 10 can use a torsion spring when used in an application in which the armature movement is translated to rotational movement of the drive mechanism. The curve 153 is the sum of curve 151, the nominal solenoid force, and the curve 154, the nominal spring load force, and thus approximates the magnetic attraction for under normal operating conditions. The armature can be manually moved (pushed) between the centered and extended positions. The curve 152 shows the magnetic force when the solenoid coils are not energized and the armature is manually moved (pushed) between the centered and extended positions.

The ramping indicated generally by the reference numeral 156 is caused at least in part by flat face attraction as the armature 12 nears the pole face 97 or end of stroke.

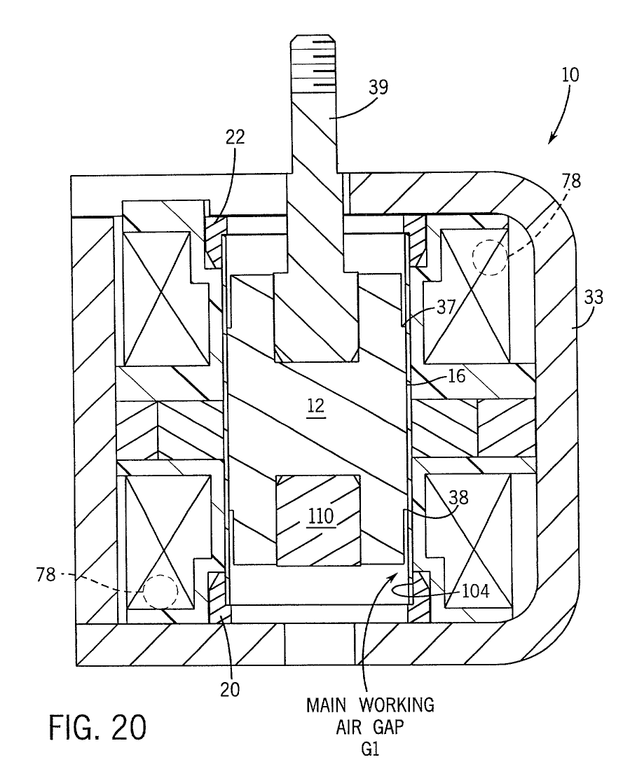

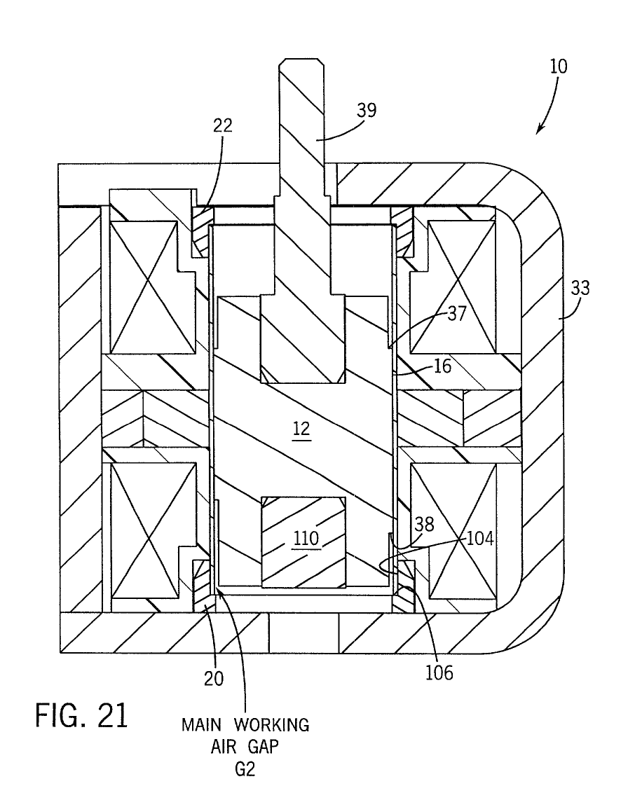

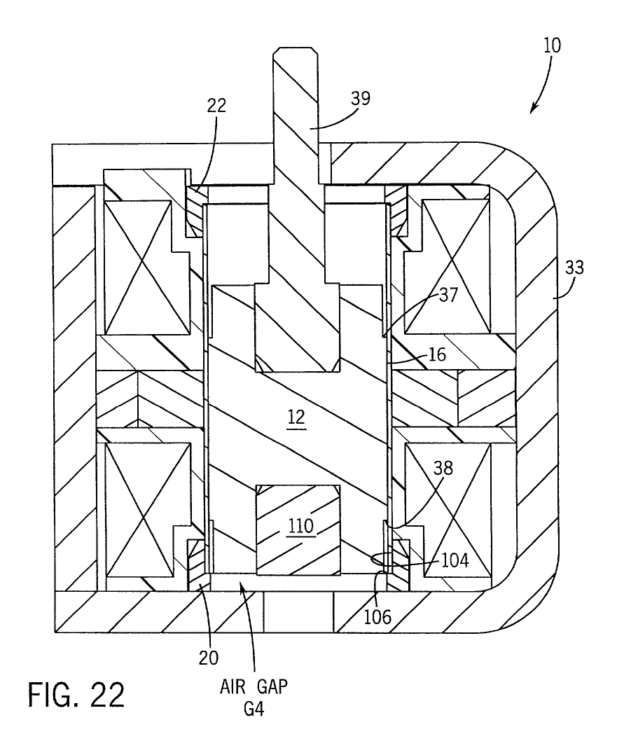

Referring to FIGS. 20-22, the stepped shunt ring 20, in combination with the shoulder 38 on the armature 12 near the armature face 29, controls the magnetic timing. When the armature 12 is in the centered position, the end or face 29 of the armature 12 is in the proximity of the larger diameter portion 102 of the shunt ring 20 and the main working air gap is indicated generally by G1. As the armature 12 is driven towards the retracted position and it face 29 approaches the shoulder 106, at the smaller diameter portion of the shunt ring 20, the main working air gap is G2. As, the armature 12 nears the retracted position, the stepped portion at shoulder 38 of the armature 12 begins to interact with the shunt ring 20 and the main working air gap is G3 and an air gap G4 which is flat face attraction. This area is shown at 158 as slightly higher forces in FIG. 23 and account for the slope of curve 154.

The shunt rings 20 and 22 and the radial air gaps G1, G2 and G3 even out the net force over the length of the stroke so that the magnetic force is substantially constant or linear, as shown in FIG. 23, once the static forces have been overcome. Changing flux coupling is produced by the stepped flux rings 20 and 22 and the stepped armature 12, including shoulder 38 on the armature, as these features come into proximity with one another.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. A solenoid comprising:
a magnetic pole member;
an armature supported for movement relative to said magnetic pole member between a first position and at least second and third positions;
a bias structure producing a bias force for maintaining said armature at said first position; and
a coil assembly producing a first magnetic flux for driving said armature against the bias force from the first position to the second position, said coil assembly producing a second magnetic flux for driving said armature against the bias force from the first position to the third position, wherein said armature is maintained by the effects of a magnetic force in a position to which said armature has been driven.

2. The solenoid according to claim 1, wherein said coil assembly includes a first solenoid coil for producing magnetic flux for driving said armature against the bias force from said first position to said second position, and a second solenoid coil for producing magnetic flux for driving said armature against the bias force from said first position to said third position.

3. The solenoid according to claim 1, wherein said magnetic pole member defines first and second substantially flat pole faces, wherein said armature includes a first substantially flat armature face opposing said first pole face and a second substantially flat armature face opposing said second pole face, and wherein said magnetic force is produced by the effects of residual magnetism.

4. The solenoid according to claim 1, wherein said magnetic force is produced by a holding current supplied to said coil assembly.

5. The solenoid according to claim 1, and further including a magnetic structure for producing said magnetic force, said magnetic structure including at least one permanent magnet.

6. The solenoid according to claim 1, wherein said magnetic structure includes a split permanent magnet assembly including first and second magnet segments.

7. The solenoid according to claim 6, wherein said first and second magnet segments are polarized axially.

8. The solenoid according to claim 6, wherein said first and second magnet segments have opposite polarities.

9. The solenoid according to claim 6, wherein each of said magnet segments includes a generally arcuate side portion and straight portions on opposite sides of said arcuate side portion.

10. The solenoid according to claim 9, wherein said magnetic structure further includes a spacer member of a magnetically permeable material interposed between said first and second magnet segments and said armature.

11. The solenoid according to claim 10, wherein said spacer member includes first and second flared portions for directing magnetic flux produced near ends of said magnet segments to said armature.

12. The solenoid according to claim 2, and further comprising a magnetic flux shunt structure including at least one magnetic shunt member of a magnetically permeable material, said magnetic shunt member located adjacent to said first pole face, said magnetic flux shunt member and being configured and arranged to shunt at least a portion of an air gap produced between said first armature face and said first pole face when said armature is in said first position to provide a low reluctance magnetic flux path through said air gap between said pole member and said armature.

13. The solenoid according to claim 12, wherein said magnetic shunt member is a ring-shaped element.

14. The solenoid according to claim 12, wherein said magnetic shunt member is located adjacent a first end of said armature, and wherein said magnetic flux shunt structure includes a further magnetic shunt member located adjacent a second end of said armature.

15. The solenoid according to claim 2, wherein the bias structure includes a single spring element for returning said armature from said second and third positions to said first position.

16. The solenoid according to claim 15, wherein said common spring element is a compression spring, the bias structure including at least first and second stop members trapping said coil spring as said armature is driven to enable said coil spring to be compressed both when said armature is driven from said first position toward said second position and from said first position toward said third position.

17. The solenoid according to claim 12, including adjustment element extending into said air gap between said armature and said magnetic pole member.

18. The solenoid according to claim 17, wherein said adjustment element is carried by said armature and is adjustable axially relative to said armature for setting the width of the air gap between said armature and said magnetic pole member.

19. A latching solenoid comprising:
a magnetic pole member;
an armature supported for movement relative to said magnetic pole member between a first position and at least second and third positions;
a bias structure producing a bias force for maintaining said armature at said first position;
a coil assembly for producing magnetic flux for driving said armature relative to said magnetic pole piece against the bias force from the first position to the second and third positions; positions; and
a magnetic structure including at least one permanent magnet producing a magnetic force for maintaining said armature in at least one of said second and third positions when said armature has been driven to said one position.

20. The latching solenoid according to claim 19, wherein said magnetic structure includes a split permanent magnet assembly including first and second magnet segments.

21. The latching solenoid according to claim 20, wherein said first and second magnet segments are polarized axially.

22. The latching solenoid according to claim 20, wherein the first and second magnet segments have opposite polarities.

23. The latching solenoid according to claim 20, wherein each of said magnet segments includes a generally arcuate side portion and straight portions on opposite sides of said arcuate side portion.

24. The latching solenoid according to claim 20, wherein said magnetic structure further includes a spacer member of a magnetically permeable material interposed between said first and second magnet segments and said armature.

25. The latching solenoid according to claim 24, wherein said spacer member includes first and second flared portions for directing the portion of the magnetic flux produced near ends of said magnet segments to said armature.

26. The latching solenoid according to claim 20, wherein said coil assembly defines a recess which receives said first and second magnet segments and said spacer member.

27. A solenoid comprising:
a pole member of a magnetic material;
an armature of a magnetic material, said armature being supported for movement relative to said pole member between a first position and at least second and third positions; and,
a coil assembly including a first solenoid coil for producing magnetic flux for driving said armature relative to said pole member to said second position, and a second solenoid coil for producing magnetic flux for driving said armature relative to said pole member from said first position to said third position, wherein said armature is maintained by the effects of a magnetic force in a position to which said armature has been driven.

28. The solenoid according to claim 27, wherein said magnetic pole member defines first and second substantially flat pole faces, wherein said armature includes a first substantially flat armature face opposing said first pole face and a second substantially flat armature face opposing said second pole face, and wherein said magnetic force is produced by the effects of residual magnetism.

29. The solenoid according to claim 27, wherein said magnetic force is produced by a holding current supplied to said coil assembly.

30. The solenoid according to claim 27, and including a magnetic structure for producing said magnetic force, said magnetic structure including at least one permanent magnet.

31. The solenoid according to claim 27, and including a drive circuit for selectively applying drive signals to said first and second solenoid coils for producing said magnetic flux, said drive circuit including a delatch circuit for causing the armature to be returned to said first position in response to loss of power.

32. The solenoid according to claim 31, wherein said delatch circuit comprises a first delatch pulse generator responsive to loss of power for applying a delatch pulse to said first solenoid coil to overcome said magnetic latching force, and a second delatch pulse generator responsive to loss of power for applying a delatch pulse to said second solenoid coil to overcome said magnetic force.

33. A method for determining the axial position of an armature of a latching solenoid, the latching solenoid including a first solenoid coil for driving said armature from a first position to a second position and a second solenoid coil for driving said armature from the first position to a third position, said method comprising the steps of:
applying a first test signal to said first solenoid coil;
determining a parameter of the current flowing through said first solenoid coil at a first time following the application of the first test signal to provide a first current parameter value;
applying a second test signal to said second solenoid coil;
determining a parameter of the current flowing through said second solenoid coil at a second time following the application of the second test signal to provide a second current parameter value; and
comparing the first current parameter value with the second current parameter value to determine the relative difference between the first and second current parameter values; and
using the results of the comparison to provide an indication of the axial position of said armature.

34. The method according to claim 33, wherein the steps of determining a parameter of the current flowing through said first and second solenoid coils include sensing the magnitude of the currents flowing through the first and second solenoid coils at a time prior to the peak amplitude of the currents.

35. The method according to claim 33, including wherein the step of using the results of the comparison includes comparing the first and second current parameter values with current values stored in a look-up table.

36. The method according to claim 33, wherein the test signal applied to said first and second solenoid coils is less than one-third a minimum drive voltage for said first and second solenoid coils and has the same polarity as said drive voltage.

37. A three-position, solenoid for actuating a functional device from a first condition to a second condition, said solenoid comprising:
a magnetic pole member;
an armature supported for movement relative to said magnetic pole member between a first position and at least second and third positions;
a bias structure producing a bias force for maintaining said armature at said first position; and
a coil assembly producing a first magnetic flux for driving said armature against the bias force from the first position to the second position, said coil assembly producing a second magnetic flux for driving said armature against the bias force from the first position to the third position, said armature maintained by the effects of a magnetic force in a position to which said armature has been driven, said armature being movable manually against the force produced by the magnetic force away from a position in which said armature has been latched.

38. The three-position solenoid according to claim 37, wherein the functional device is a lock mechanism, and wherein one of said conditions corresponds to a locking position for the lock mechanism and a further one of said conditions corresponds to an unlocking position for the lock mechanism.
